(19) United States
(12) Patent Application Publication
(10) Pub. No.: US 2023/0339759 A1
(43) Pub. Date: Oct. 26, 2023

(54) GRAPHENE COMPOSITE MATERIALS AND METHODS OF MANUFACTURING THE SAME

(71) Applicant: Enerage Inc., Yilan County (TW)

(72) Inventor: Mark Y. Wu, Yilan County (TW)

(21) Appl. No.: 17/859,821

(22) Filed: Jul. 7, 2022

(30) Foreign Application Priority Data
Apr. 26, 2022 (TW) 111115893

(51) Int. Cl. C01B 32/184

(52) U.S. Cl. CPC C01B 32/184

(57) ABSTRACT

The present invention discloses a graphene composite material including a columnar substrate and graphene sheets, wherein the columnar substrate accounts for 99.9-90% of overall weight, the graphene sheets accounts for 0.1-10% of overall weight, and the graphene sheets form a plurality of circular patterns of different radii on a radial section of the columnar substrate. The present invention further discloses a method of manufacturing the graphene composite material including: providing a columnar substrate and graphene sheets; rotationally rubbing the columnar substrate to form a plasticized substrate; applying shear force to stir the plasticized substrate and the graphene sheets to form a graphene-substrate slurry; and cooling the graphene-substrate slurry to form a graphene composite material.

### CROSS-REFERENCE TO RELATED APPLICATION

This application claims the priority of Taiwanese patent application No. 111115893, filed on Apr. 26, 2022, which is incorporated herewith by reference.

### BACKGROUND OF THE INVENTION

### 1. Field of the Invention

The present invention relates to a composite material and a method of manufacturing the same, and more particularly, to a graphene composite material and a method of manufacturing the same.

### 2. The Prior Arts

As the development of science and technology and the rising of environmental consciousness, the requirements for properties, such as electrical conductivity, thermal conductivity, mechanical strength, weather resistance, manufacturing cost, of materials in industrial fields, such as electrical engineering, electronics, chemical engineering, transportation, mechanics, are also getting higher and higher. Taking conductive materials as an example, copper has an electrical conductivity higher than that of aluminum, but has poor mechanical strength and poor high-temperature deformation resistance; while taking the casing material of aircraft as an example, aluminum has low density, high strength and high ductility, but has poor corrosion resistance and poor impact resistance; therefore, in the prior arts, the composite materials with required properties are manufactured by means of alloys, additives, heat treatment, etc.

Existing composite materials include metal matrix composites, ceramic matrix composites and resin matrix composites, etc. Among them, Metal Matrix Composites (MMCs) refer to composite materials produced by mixing metal substrate and reinforcing phase materials, MMCs have the advantages of both metal and reinforcing phase materials. In the industry, methods such as powder metallurgy, mold casting are often used to manufacture MMCs. In the powder metallurgy, MMCs are formed mainly by performing mechanical mixing powders of the metal and the reinforcing phase materials, and then processing the mixed materials by methods such as pressureless sintering, vacuum hot pressing sintering, high pressure torsion, hot extrusion, hot rolling.

FIG. 1 shows a schematic cross-sectional view of a mold casting equipment of the prior art. As shown in FIG. 1, a mold casting equipment 1 includes an oil hydraulic cylinder 11, a piston 12, a compression chamber 13, and a cooling chamber 14. A reinforcing phase material is placed into the compression chamber 13, a molten metal slurry is injected into the compression chamber 13 and mixed with the reinforcing phase material, and the oil hydraulic cylinder 11 drives the piston 12 to squeeze the mixture of metal and reinforcing phase material into the cooling chamber 14 for cooling and forming. In the existing mold casting, the core technologies for manufacturing metal matrix composites is in that the reinforcing phase material is uniformly dispersed in the molten metal without occurring of phase separation among different materials during the cooling and forming process.

Among many reinforcing phase materials, graphene is a two-dimensional material with a single layer of honeycomb lattice of carbon atoms, which has extremely high Young's modulus, tensile strength, electrical conductivity, thermal conductivity, and electron mobility, and therefore has received extremely high attention and research. Due to the instability of two-dimensional crystals in terms of thermodynamic properties, whether the graphene exists in a free state or is deposited in a substrate, the graphene is not completely flat, with microscopic three-dimensional scale wrinkles on its surface, such wrinkles will cause agglomeration of the graphene due to Van der waals force, and the wettability between the graphene and the metal substrate is poor, thereby it is more difficult for graphene to be uniformly dispersed in the substrate. In the existing mold casting equipment and manufacturing methods, the problem of agglomeration of graphene in molten metal cannot be overcome, and thus metal/graphene composite materials cannot be successfully manufactured.

China Patent Publication No. CN105215353 A discloses a method of manufacturing a metal/graphene composite material including: reducing graphene oxide at the surface of metal particles to produce graphene-wrapped metal particles; and thermally pressing the graphene-wrapped metal particles by powder metallurgy to produce a metal/graphene composite material. In this method, the steps are complicated, it is difficult to control the relative ratio of metal and graphene, and impurities are prone to be introduced in the manufacturing process, while the in situ reduction of graphene oxide cannot completely remove functional groups and lattice defects on the surface of graphene; and thus this composite material cannot generate the properties of graphene. In other technical literatures, method such as ultrasonic dispersion, wet mechanical stirring, ball milling, planetary high-energy ball milling, surface modification, electrostatic adsorption are proposed to promote the dispersion and mixing of graphene in metal powder or metal liquid. However, none of the aforementioned methods can overcome the agglomeration problem on using a relatively large amount of graphene, a scale-up production cannot be achieved thereby, so that the aforementioned methods do not have practicability.

At present, a graphene composite material with graphene characteristics and a method of manufacturing the same, which can control a ratio of component and achieve a scale-up production, are urgently needed in the industries.

### SUMMARY OF THE INVENTION

In order to achieve the above objectives, the present invention provides a method of manufacturing a graphene composite material including: providing a columnar substrate and graphene sheets; rotationally rubbing the columnar substrate to form a plasticized substrate; applying a shear force to stir the plasticized substrate and the graphene sheets to form a graphene-substrate slurry; and cooling the graphene-substrate slurry to form a graphene composite material.

In an embodiment, a material of said columnar substrate is metal, alloy or polymer.

In an embodiment, said metal is selected from at least one of lead, tin, zinc, aluminum and copper.

In an embodiment, a weight ratio of said columnar substrate to said graphene sheets is 99.9-90%:0.1-10%.

In an embodiment, the plasticized substrate is formed by rotationally rubbing a surface of said columnar substrate with a rotating mold, to allow a temperature of the columnar substrate reach between 70% and 100% of a melting point of the columnar substrate.

In an embodiment, said shear force stirring said graphene sheets and said plasticized substrate to form said graphene-substrate slurry is applied by a rotating flow channel, which is located inside said rotating mold.

In an embodiment, said rotating mold includes an outer mold and an inner mold, said rotating flow channel is located between the outer mold and the inner mold, the outer mold has inner lugs formed on an inner surface thereof, the inner mold has outer lugs formed on an outer surface thereof, the inner lugs and the outer lugs are in a stagger arrangement, when the outer mold rotates relative to the inner mold, the inner lugs and the outer lugs generate said shear force.

In order to achieve the above objectives, the present invention provides a graphene composite material including: a columnar substrate accounting for 99.9-90% of an overall weight; and graphene sheets accounting for 0.1-10% of the overall weight, wherein the graphene sheets form a plurality of circular patterns of different radii on a radial section of the columnar substrate.

In an embodiment, an average thickness of said graphene sheets is between 1 and 3 nm, and an average diameter of each of said graphene sheets is between 1 and 15 μm.

In the method of manufacturing the graphene composite material according to the present invention, the weight ratio of the graphene sheets to the substrate can be exactly controlled by using the columnar substrate as the raw material, the plasticized substrate is formed by rotationally rubbing the columnar substrate, and then the plasticized substrate in a thixotropic state and the graphene sheets are stirred by high shear force, thereby the graphene composite material is formed. The steps are simple, no chemical reduction reaction is required, no impurities are introduced, and no lattice defects are generated. In the graphene composite material, the graphene sheets and the columnar substrate are uniformly mixed without phase separation, the graphene sheets form the plurality of circular patterns of different radii on the radial section of the columnar substrate, the graphene sheets are in a spiral arrangement along the axial direction of the columnar substrate, and there is no phase separation between the graphene sheets and the substrate. Due to the uniformly distributed and continuously interconnected graphene sheets, the graphene composite material can have excellent electrical conductivity, thermal conductivity and mechanical strength, which meets the various requirements of the industries.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic cross-sectional view of the mold casting equipment of the prior art;

FIG. 2 is a schematic side cross-sectional view of a horizontal type composite material manufacturing equipment utilizing the method of the present invention, FIG. 2A is a schematic side cross-sectional view of the oil hydraulic unit shown in FIG. 2, FIG. 2B is a schematic side cross-sectional view of the feeding mold shown in FIG. 2, FIG. 2C is a schematic side cross-sectional view of the rotating mold shown in FIG. 2, FIG. 2D is a schematic side cross-sectional view of cooling mold shown in FIG. 2, FIG. 2E is a schematic side cross-sectional view of the forming mold shown in FIG. 2, FIG. 2F is a schematic cross-sectional view of section I-I′ in FIG. 2, FIG. 2G is a schematic view of the radial appearance of the first inner mold shown in FIG. 2C;

FIG. 3A is a schematic side cross-sectional view of a vertical type composite material manufacturing equipment utilizing the method of the present invention, FIG. 3B is a schematic view of the radial appearance of the rubbing head shown in FIG. 3A; and

FIG. 4A is an optical microscope image of a cross-section of a graphene-metal copper composite material according to an embodiment of the present invention, FIG. 4B is an electron microscope image of a cross-section of the graphene-metal copper composite material according to the embodiment of the present invention.

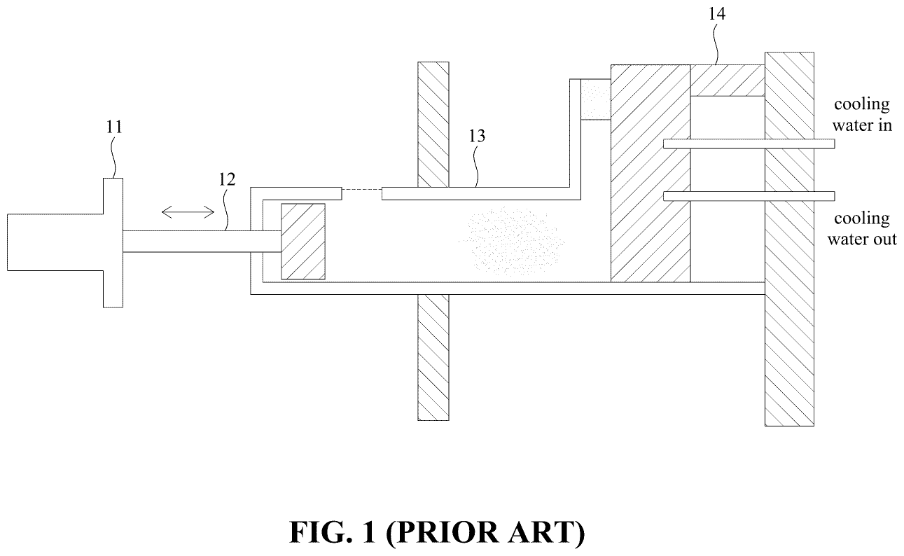

### DETAILED DESCRIPTION OF THE EMBODIMENTS

Hereinafter, the embodiments of the present invention will be described in more detail with reference to the drawings and reference numerals, in order that those skilled in the art can implement the present invention accordingly after studying the present specification. The terminology used herein is used to describe specific embodiments only, and is not intended to limit the present invention. Unless it is clearly indicated in the context otherwise, the terms used herein include both singular and plural forms, and the term “and/or” includes any and all combinations of one or more of the associated listed items.

A solid material under the rubbing of external force will generated particles with a size of less than 20 μm on its surface, a temperature of the solid material rises to a critical temperature Tc for plasticization (which is between the melting point Tm of the solid material and 70% of the melting point Tm) by continuously applying force to rub it, and the plasticized material can generate thixotropy by repeatedly cooling and rubbing to heat it and simultaneously applying varying shear force thereto. Thixotropy refers to the phenomenon that a viscosity of an object becomes less (or greater) when the object receives the shear force, while the viscosity of the object becomes greater (or less) when the shear force is stopped; that is, the structure of the object changes reversibly and has superplasticity (the object has a particularly high elongation and will not be broken). The material with thixotropy generated has an appearance of paste-like slurry state (the volume of solid phase accounts for up to 80%), and contains fine crystal particles which are not connected to each other in the interior. Continuous to stir the thixotropic slurry can prevent the fine crystal particles from contacting with each other and thus forming large crystal particles; at this time, if other materials of appropriate size are mixed with the thixotropic slurry by a specific method, the effect of uniformly dispersing the materials can be achieved.

In the present invention, a uniformly dispersed graphene composite material is produced by utilizing the plasticity and thixotropy of the solid substrate, the method of manufacturing the graphene composite material according to the present invention includes: providing a columnar substrate and graphene sheets; rotationally rubbing the columnar substrate to form a plasticized substrate; applying shear force to stir the plasticized substrate and the graphene sheets to form a graphene-substrate slurry; and cooling the graphene-substrate slurry to form a graphene composite material.

The material of the columnar substrate is metal, alloy or polymer, wherein the metal can be selected from at least one of lead, tin, zinc, aluminum and copper; the alloys is, for example, but not limited to, aluminum alloys, copper alloys; the polymer is, for example, but not limited to, polyethylene (PE), polypropylene (PP), acrylic copolymers, polyethylene terephthalate (PET), polyimide (PI), acrylonitrile-butadiene-styrene copolymer (ABS), polyether ether ketone (PEEK), nylon, etc. Each of the graphene sheets include a plurality of layers of graphene, the average thickness of the graphene sheets is between 1 and 3 nm, and the average diameter of the graphene sheets is between 1 and 15 μm. The weight ratio of the columnar substrate to the graphene sheets is 99.9-90%:0.1-10%.

In the method of manufacturing the graphene composite material according to the present invention, the critical temperature Tc for plasticization of the columnar substrate is between 70% of the melting point Tm of the columnar substrate and the melting point Tm (for example, Tc=0.7 Tm˜0.9 Tm). Taking the metal and alloy materials as examples, under no inert gas protection, the composite material of graphene and lead, tin, zinc, aluminum or aluminum alloy can be manufactured at the plasticizing temperature lower than 700° C.; under the inert gas protection, the composite material of graphene and copper or copper alloy can be manufactured at the plasticizing temperature lower than 1100° C.

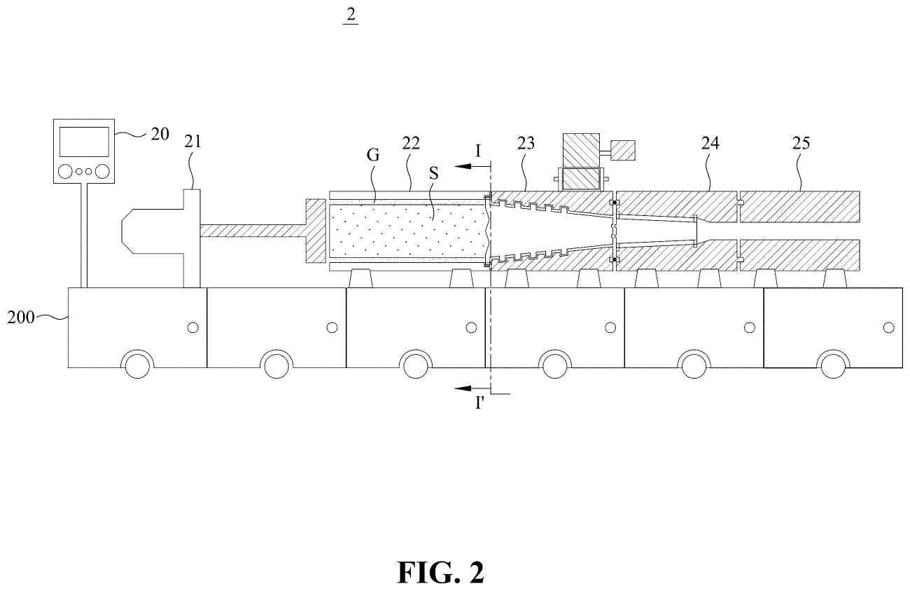

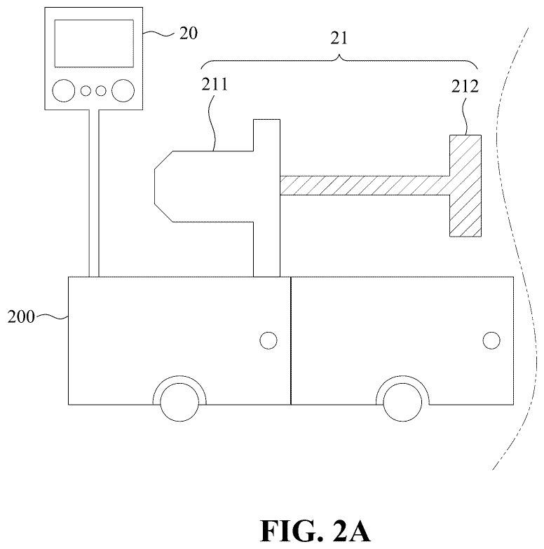

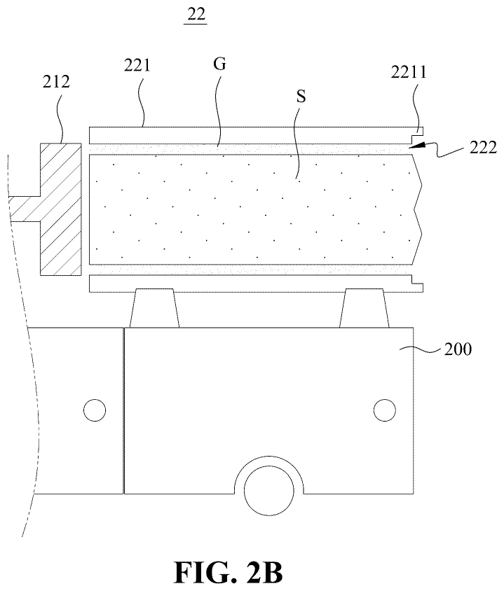

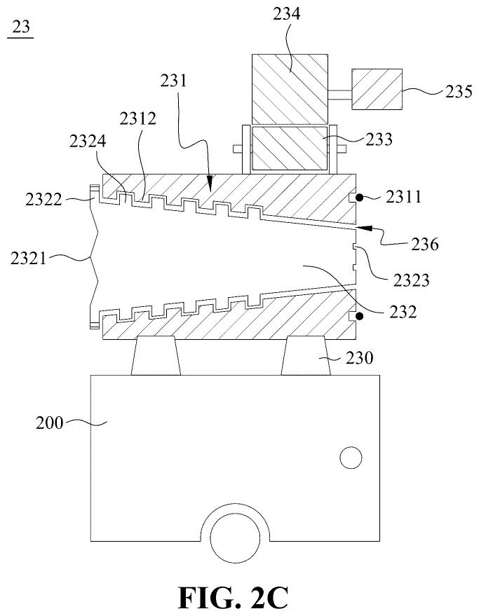

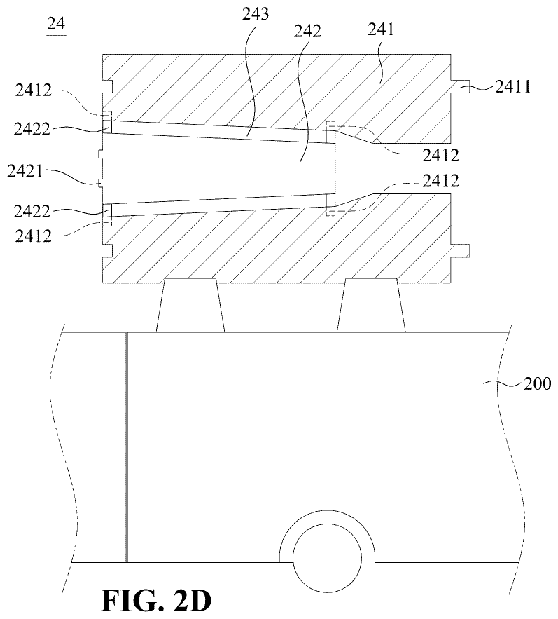

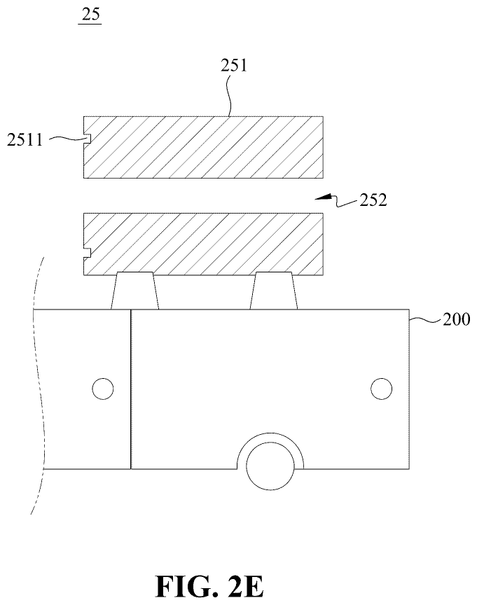

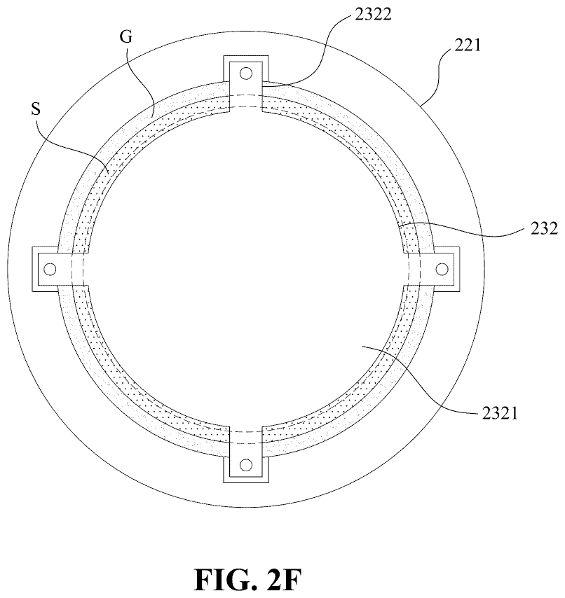

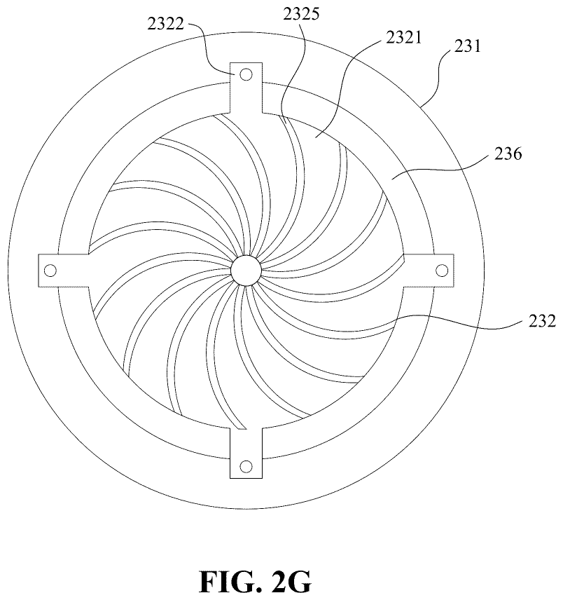

FIG. 2 is a schematic side cross-sectional view of a horizontal type composite material manufacturing equipment utilizing the method of manufacturing according to the present invention; FIG. 2A is a schematic side cross-sectional view of the oil hydraulic unit shown in FIG. 2; FIG. 2B is a schematic side cross-sectional view of the feeding mold shown in FIG. 2; FIG. 2C is a schematic side cross-sectional view of the rotating mold shown in FIG. 2; FIG. 2D is a schematic side cross-sectional view of cooling mold shown in FIG. 2; FIG. 2E is a schematic side cross-sectional view of the forming mold shown in FIG. 2.

As shown in FIGS. 2 and 2A, a control unit (not shown) of the horizontal type composite material manufacturing equipment 2 is connected to the oil hydraulic unit 21, the feeding mold 22, the rotating mold 23, the cooling mold 24, and the forming mold 25; and the control unit includes a control interface 20, through which the parameters for the operation of the equipment (for example, the pushing and squeezing pressure of the piston, the rotation speed of the rotating mold) can be input and adjusted. The oil hydraulic unit 21, the feeding mold 22, the rotating mold 23, the cooling mold 24, and the forming mold 25 are arranged horizontally, and fixed on a movable carrying platform 200 with bolts. The oil hydraulic unit 21 includes an oil hydraulic cylinder 211 and a piston 212, and the oil hydraulic cylinder 211 and the piston 212 can push and squeeze the raw material in the feeding mold 22.

As shown in FIGS. 2 and 2B, the feeding mold 22 of the horizontal type composite material manufacturing equipment 2 includes a raw material cylinder 221 and a raw material chamber 222 inside the raw material cylinder 221. A size of an inner diameter of the raw material chamber 222 corresponds to that of an outer diameter of the piston 212. The raw material cylinder 221 is made of materials with high melting point and high strength, such as metal alloys like tungsten, manganese, molybdenum, or ceramic alloys like tungsten carbide, and thus can withstand the pushing and squeezing of the piston 212 without deformation. Four inwardly retracted threaded holes 2211 are formed at the side of the raw material cylinder 221 connected to the rotating mold 23. The raw material chamber 222 can accommodate a columnar substrate S and graphene sheets G.

As shown in FIGS. 2 and 2C, the rotating mold 23 of the horizontal type composite material manufacturing equipment 2 is disposed on rolling bearings 230, and includes a first outer mold 231, a first inner mold 232, a speed change gear 233, a coupling gear set 234, and a variable frequency motor 235. The first outer mold 231 can be opened and closed by 180° for assembly and cleaning. The first inner mold 232 is disposed inside the first outer mold 231. Two sides of the first inner mold 232 are respectively connected to the feeding mold 22 and the cooling mold 24. The speed change gear 233 meshes with the ratchets (not shown) of the first outer mold 231 and the coupling gear set 234, respectively. The speed change gear 233, the coupling gear set 234, and the variable frequency motor 235 are fixed on the carrying platform 200 by bolts, respectively. The variable frequency motor 235 is connected to the coupling gear set 234. The variable frequency motor 235 drives the first outer mold 231 to rotate through the coupling gear set 234 and the speed change gear 233.

The first outer mold 231 has a thickness gradually increasing from the side of the feeding mold 22 to the side of the cooling mold 24 (along the axial direction), which is in a funnel shape. A feed port with a greater opening size and a discharge port with a less opening size are formed at two sides of the first outer mold 231 on the radial direction, respectively. The side wall of the feed port of the first outer mold 231 is aligned with the raw material cylinder 221. A circular groove is formed on the side wall of the discharge port of the first outer mold 231, wherein a rotating shaft 2311 is provided in the circular groove. The first outer mold 231 has inner lugs 2312 formed on the inner surface thereof from the feed port to the middle section. The first outer mold 231 can be opened and closed by 180° along the axial direction for facilitating assembly and cleaning. A conical surface 2321 protruding beyond the feed port of the first outer mold 231 is formed on the side of the first inner mold 232 facing the feed mold 22. The periphery of the conical surface 2321 is provided with four ribs 2322. Each of the ribs 2322 is provided with a through hole thereon for bolts to pass through. The vertical surface of the first inner mold 232 facing the cooling mold 24 is aligned with the discharge port of the first outer mold 231, wherein a groove 2323 is formed on the vertical surface. The first inner mold 232 has outer lugs 2324 formed on the outer surface thereof from the conical surface to the middle section. The four ribs 2322 of the first inner mold 232 are aligned with and inserted into the four threaded holes 2211 of the raw material cylinder 221, such that the first inner mold 232 and the raw material cylinder 221 can be fixed with bolts. Two grooves 2323 of the first inner mold 232 are coupled to the cooling mold 24, such that the first inner mold 232 can be fixed to the feed mold 22 and the cooling mold 24 at two sides thereof, respectively; then the side wall of the feeding port of the first outer mold 231 is attached to the side wall of the raw material cylinder 221, and the first outer mold 231 is closed; thereby the first outer mold 231 and the first inner mold 232 are separated by a distance not greater than 5 cm, and the inner lugs 2312 of the first outer mold 231 and the outer lugs 2324 of the first inner mold 232 are in a stagger arrangement. Accordingly, a rotating flow channel 236 extending at an oblique angle of 15-30° with respect to the horizontal direction is formed between the first outer mold 231 and the first inner mold 232. The first outer mold 231 and the first inner mold 232 are each made of materials with high melting point and high strength (such as metal alloys like tungsten, manganese, molybdenum, or ceramic alloys like tungsten carbide), and thus can withstand the high temperature and stress generated during rubbing the substrate without deformation.

As shown in FIGS. 2 and 2D, the cooling mold 24 of the horizontal type composite material manufacturing equipment 2 includes a second outer mold 241 and a second inner mold 242. The second outer mold 241 has a thickness gradually increases from the side connected to the rotating mold 23 to the side connected to the forming mold 25 (along the axial direction). A feed port with a greater opening size and a discharge port with a less opening size are formed on two sides of the second outer mold 241 on the radial direction, respectively. The opening size of the feed port of the second outer mold 241 is equal to that of the discharge port of the first outer mold 231. A circular groove is formed on the side wall at the feed port of the second outer mold 241, wherein the rotating shaft 2311 is accommodated in the circular groove. A bump 2411 is formed on the side wall at the discharge port of the second outer mold 242, and the bump 2411 can be coupled to the forming mold 25. Plural bumps 2421 are formed on the side of the second inner mold 242 facing the rotating mold 23, and the bumps 2421 can be coupled to the groove 2323 of the first inner mold 231. The second inner mold 242 is provided with four ribs 2422 on each of two opposite sides, and threaded holes 2412 corresponding to the ribs 2422 are formed on the second outer mold 241, such that the second outer mold 241 and the second inner mold 242 can be fixed with bolts. A cooling flow channel 243 extending at an oblique angle of 15-30° with respect to the horizontal direction is formed in the gap of about 3 cm between the inner surface of the second outer mold 241 and the outer surface of the second inner mold 242. By aligning and attaching the feed port of the second outer mold 241 to the discharge port of the first outer mold 231, the rotating flow channel 236 and the cooling flow channel 243 can be communicated with each other. The portion of each rib 2422 exposed to the cooling flow channel 243 is processed into a round shape, which can prevent the graphene-substrate slurry from accumulating and then blocking the passing of graphene-substrate slurry through the cooling flow channel 243.

As shown in FIGS. 2 and 2E, the forming mold 25 of the horizontal type composite material manufacturing equipment 2 includes a finished product cylinder 251 and a finished product chamber 252 inside the finished product cylinder 251. The finished product cylinder 251 is made of materials with high melting point and high strength, and the finished product cylinder 251 can be opened and closed along the axial direction. A groove 2511 is formed on a side wall of the finished product cylinder 251 facing the cooling mold 24. The groove 2511 can be coupled to the bump 2411 of the second outer mold 241. A size of an inner diameter of the finished product chamber 252 is equal to the opening size of the discharge port of the second outer mold 241.

By using the above-mentioned horizontal type composite material manufacturing equipment to manufacture the graphene composite material, the substrate (e.g., copper, aluminum) can be formed as a single column or a plurality of columns (circular column, corner column), the outer diameter and volume of the columnar substrate S are less than the inner diameter and volume of the raw material chamber 222, respectively, the columnar substrate S is placed into the raw material chamber 222, and then the raw material chamber 222 is filled up with the graphene sheets G (that is, the gap between the columnar substrate S and the cylinder 221 is filled with the graphene sheets G) to cover the columnar substrate S; alternatively, the substrate can be made into the columnar substrate with the diameter same as the inner diameter of the raw material chamber 222, one or more filler hole(s) with a same diameter is(are) formed along the axial direction of the columnar substrate with a drilling tool, and then the graphene sheets are filled into the filler hole(s). By using the columnar substrate as the raw material, it is easy to control and adjust the relative weight ratio of the substrate to the graphene sheets in the graphene composite material.

FIG. 2F is a schematic cross-sectional view of section I-I′ in FIG. 2. As shown in FIGS. 2, 2C and 2F, a recess that fitting the shape of the conical surface 2321 and the ribs 2322 of the first inner mold 232 is formed on the side of the columnar substrate S facing the rotating mold 23. The ribs 2322 of the first inner mold 232 are fixed into the inwardly retracted threaded holes 2211 of the raw material cylinder 221; meanwhile, the conical surface 2321 of the first inner mold 232 is embedded into the recess of the columnar substrate S. The portion of the periphery of the recess of the columnar substrate S exposed to the first inner mold 232 is aligned with the vertical surface of the side wall of the raw material cylinder 221. The thickness of the side wall of the feed port of the first outer mold 231 is greater than the thickness of the side wall of the raw material cylinder 221. Accordingly, a shoulder of the side wall of the feed port of the first outer mold 231 that extends beyond the side wall of the raw material cylinder 221 (the position illustrated by the dotted line shown in FIG. 2F) can be attached to the exposed portion of the columnar substrate S and the graphene sheets G. When the variable frequency motor 235 is started to drive the first outer mold 231 to rotate, the plasticized substrate is formed due to the high heat generated by the shoulder of the side wall of the first outer mold 231 rotationally rubbing the exposed portion of the columnar substrate S, and then the piston 212 pushes and squeezes the plasticized substrate and the graphene sheets G into the rotating flow channel 236.

FIG. 2G is a schematic view of the radial appearance of the first inner mold shown in FIG. 2C. As shown in FIGS. 2, 2C and 2G, the conical surface 2321 of the first inner mold 232 is in close contact with the recess of the surface of the columnar substrate S, and a plurality of spiral guide grooves 2325 are formed on the conical surface 2321, wherein the depth of the spiral guide grooves 2325 is not greater than 5 mm. The first outer mold 231 rotationally rubs the columnar substrate S around the first inner mold 232 to form the plasticized substrate, the piston 212 pushes and squeezes the plasticized substrate and the graphene sheets into the rotating flow channel 236 along the spiral guide grooves 2325. In the rotating flow channel 236, the heights of the inner lugs 2312 of the first outer mold 231 and the outer lugs 2324 of the first inner mold 232 are about 1 to 3 cm, the staggered inner lugs 2312 and outer lugs 2324 rotate relative to each other, thereby generating the shear force that continuously rubs and stirs the plasticized substrate and the graphene sheets, to allow the crystallization and eutectic crystal of the plasticized substrate be gradually fined, thereby producing thixotropic graphene-substrate slurry. The fined crystal grains of the substrate in the graphene-substrate slurry are not connected to each other, such that the graphene sheets can be dispersed among the crystal grains of the substrate without agglomeration. Due to the pushing and squeezing pressure of the piston 212 and the shear force generated by the rotating flow channel 236, the graphene sheets and the crystal grains of the substrate pass through the rotating flow channel 236 in a spiral arrangement. The graphene-substrate slurry passing through the cooling flow channel 243 is gradually cooled to be a semi-solid composite material, and the graphene sheets in a spiral arrangement and connected with each other are gradually fixed on the surface of the crystal grains of the substrate. Due to the pushing and squeezing pressure of the piston 212, the semi-solid composite material is further extruded into the forming mold 25 then solidified, and a columnar graphene composite material is formed. There is no occurring of phase separation between the graphene sheets and the substrate, such that the composite material possesses excellent properties of graphene.

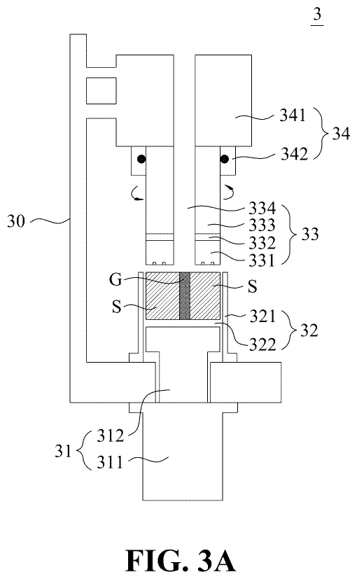

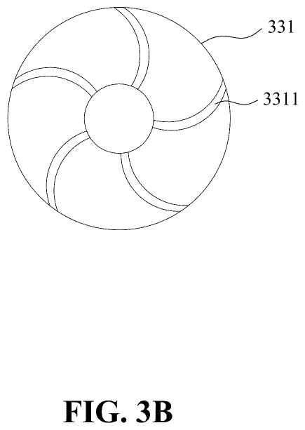

FIG. 3A is a schematic side cross-sectional view of a vertical type composite material manufacturing equipment applying the method of manufacturing the graphene composite material according to the present invention; FIG. 3B is a schematic view of the radial appearance of the rubbing head shown in FIG. 3A. As shown in FIGS. 3A and 3B, a vertical type composite material manufacturing equipment 3 includes a support frame 30, an oil hydraulic unit 31, a feeding mold 32, a rotating mold 33, and a power unit 34. The oil hydraulic unit 31, the feeding mold 32, the rotating mold 33, and the power unit 34 are arranged along the vertical direction of the support frame 30. The oil hydraulic unit 31 includes an oil hydraulic cylinder 311 and a piston 312. The feeding mold 32 includes a raw material cylinder 321 and a raw material chamber 322. The rotating mold 33 includes a rubbing head 331, a thermal insulation layer 332, a guide cylinder 333, and a rotating flow channel 334. A plurality of spiral guide grooves 3311 is formed on a rubbing surface of the rubbing head 331. The power unit 34 includes a motor gear box 341 and a ball bearing 342.

The raw material cylinder 321, the rubbing head 331, and the guide cylinder 333 are each made of materials with high melting point and high strength, such as metal alloys like tungsten, manganese, molybdenum, or ceramic alloys like tungsten carbide. The thermal insulation layer 332 is made of ceramic thermal insulation material to prevent the high temperature, which is generated by the rubbing head 331 rotationally rubbing the columnar substrate, from being conducted to the guide cylinder 333.

In this embodiment, the columnar substrate S (for example, copper, aluminum, or other metals) has a hole drilled along an axial direction thereof according to a predetermined graphene weight ratio, and the hole is filled with graphene sheets G. The columnar substrate S and the graphene sheets G are placed into the raw material chamber 322. The power unit 34 drives the rotating mold 33 to counterclockwise rub the columnar substrate S with high torque, to allow a temperature of the columnar substrate S rise to the critical temperature Tc for plasticization, thereby forming a thixotropic plasticized substrate. The piston 312 of the oil hydraulic unit 31 pushes and squeezes the plasticized substrate and the graphene sheets G with a constant stroke, the plasticized substrate is mixed with the graphene sheets through a plurality of spiral guide grooves 3311 and enters the rotating flow channel 334, thereby forming a graphene-substrate slurry. The piston 312 pushes and squeezes the graphene-substrate slurry to move upward against gravity, and the inner wall of the rotating flow channel 334 applies a shear force to the graphene-substrate slurry on the rotating direction at the same time, so that the graphene sheets G gradually form a spiral arrangement in the plasticized substrate during the graphene-substrate slurry moving upward by torsion. The thermal insulation layer 332 can effectively prevent the high temperature generated by the rubbing head 331 from being conducted to the guide cylinder 333. The graphene-substrate slurry passing through the guide cylinder 333 is gradually cooled down, thereby forming a graphene composite material. The piston 312 pushes and squeezes the graphene composite material out of the rotating flow channel 334, and thus a columnar graphene composite material is obtained.

A graphene composite material manufactured according to the present invention includes a columnar substrate and graphene sheets, wherein the columnar substrate accounts for 99.9-90% of overall weight, the graphene sheets accounts for 0.1-10% of overall weight, and the graphene sheets form a plurality of circular patterns of different radii on a radial section of the columnar substrate. An average thickness of the graphene sheets is between 1 and 3 nm, and an average diameter of the graphene sheets is between 1 and 15 μm.

Hereinafter, the present invention will be specifically illustrated with embodiments, so that those skilled in the art can more clearly understand the technology and effects of the present invention.

### Embodiment 1: A Graphene-Metal Copper Composite Material

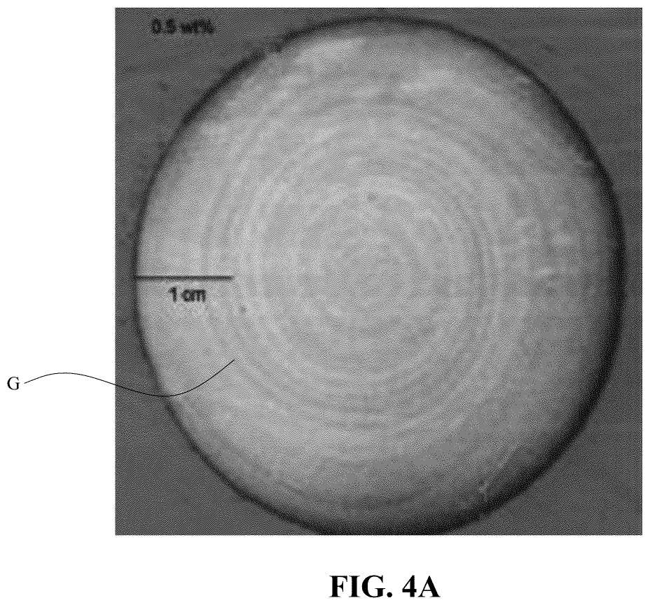

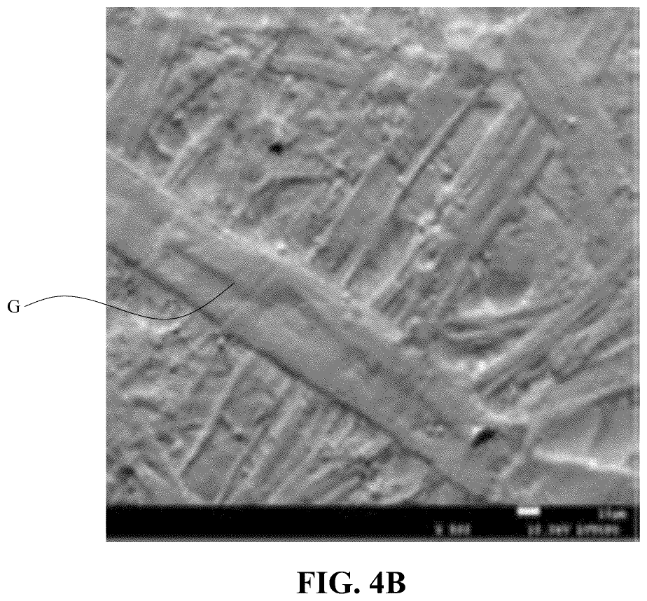

The raw materials include: 0.5 wt % of graphene sheets (multilayer graphene powder P-ML20 produced by Enerage Inc. with a carbon content >99%, a specific surface area of 45 m²/g, an average thickness of about 3 nm, an average diameter of about 8 mm); and 99.5 wt % of electrolytic copper (with copper purity >99.5%, which is formed as metal copper column with a diameter of 9 cm). The copper rod is rubbed at 200 rpm with the rotating mold until it reaches 750° C., and pushed to advance 10 mm per minute by the piston with a force of 50 kilonewtons (kN), and thus a graphene-metal copper composite material is obtained. FIG. 4A is an optical microscope image of a cross-section of the graphene-metal copper composite material of this Embodiment; FIG. 4B is an electron microscope image of a cross-section of the graphene-metal copper composite material of this embodiment. As shown in FIG. 4A, the graphene-metal copper composite material includes a metal copper column and graphene sheets G. It can be clearly observed that the graphene sheets form a plurality of circular patterns of different radii on the radial section of the metal copper column; moreover, as shown in FIG. 4B, it can be observed that there is no phase separation between the graphene sheets G and the metal copper. It is noted that a plurality of graphene sheets interconnections in a spiral arrangement along the axial direction of the metal copper column can be observed (not shown). The uniformly distributed graphene sheets interconnections can provides the inherently excellent properties of graphene, such that the graphene-metal copper composite material has the properties of electrical conductivity, thermal conductivity, and mechanical strength higher than those of metal copper, thereby the composite material can be subsequently processed into required products (such as cooling fin, wires, etc.) by processes such as forging, rolling. The measured results of hardness and electrical conductivity of the metal copper and the graphene-metal copper composite material of this embodiment are shown in Table 1 below.

TABLE 1

| | | Electrical |
|---|---|---|
| | Vickers | conductivity |
| Material | hardness | (ASTM) |
| Metal copper | 44 | 57.8 MS/m |
| | | (99.7% IACS) |
| Graphene-metal copper | 105 | 60 MS/m |
| composite material | | (104% IACS) |

### Embodiment 2: A Graphene-Aluminum Alloy Composite Material of

The raw materials include: 0.5 wt % of graphene sheets (multilayer graphene powder P-ML20 produced by Enerage Inc. with a carbon content >99%, a specific surface area of 45 m²/g, an average thickness of about 3 nm, an average diameter of about 8 mm); and 99.5 wt % of aluminum alloy (ASTM 6061, which is formed as aluminum alloy rod with a diameter of 9 cm). The aluminum alloy rod is rubbed at 250 rpm with the rotating mold until it reaches 550° C., and pushed to advance 15 mm per minute by the piston with a force of 45 kilonewtons (kN), and thus a graphene-aluminum alloy composite material is obtained. The uniformly distributed graphene sheets can provides the inherently excellent properties of graphene, such that the graphene-aluminum alloy composite material of has the properties of electrical conductivity, thermal conductivity, and mechanical strength higher than those of aluminum alloy, thereby the composite material can be subsequently processed into required products (such as electronic devices and aircraft casings, etc.). The measured results of hardness and thermal conductivity of the aluminum alloy raw material and the graphene-aluminum alloy composite material of this embodiment are shown in Table 2 below.

TABLE 2

| | | | Thermal |
|---|---|---|---|
| | Vickers | | conductivity |
| Material | hardness | Tension | (W/m · K) |
| Aluminum alloy | 75 | 340 MPa | 164 |
| Graphene and | 120 | 480 MPa | 240 |
| aluminum alloy | | | |
| composite material | | | |

In summary, in the method of manufacturing the graphene composite material according to the present invention, the weight ratio of the graphene sheets to the substrate can be exactly controlled by using the columnar substrate as the raw material, the plasticized substrate is formed by rotationally rubbing the columnar substrate, and the graphene composite material is formed by using the high shear force to disperse and mix the graphene sheets and the plasticized substrate; the steps of the method are simple, no chemical reduction reaction is required, no impurities are introduced, and no lattice defects are generated. In the graphene composite material, the graphene sheets form the plurality of circular patterns of different radii on the radial section of the columnar substrate, the graphene sheets are in a spiral arrangement along the axial direction of the columnar substrate, and there is no phase separation between the graphene sheets and the substrate, so that the graphene composite material has excellent electrical conductivity, thermal conductivity and mechanical strength, and meets the various requirements in the industries.

The above-mentioned embodiments only exemplify the principles and effects of the present invention, but are not intended to limit the present invention. Any person skilled in the art can modify and change the above-mentioned embodiments without departing from the spirit and scope of the present invention. Therefore, all equivalent modifications or changes accomplished without departing from the spirit and technical principles disclosed in the present invention by those skilled in the art should falls within the scope of the claims of the present invention.

What is claimed is:

1. A method of manufacturing a graphene composite material, comprising:
providing a columnar substrate and graphene sheets;
rotationally rubbing the columnar substrate to form a plasticized substrate;
applying a shear force to stir the plasticized substrate and the graphene sheets to form a graphene-substrate slurry; and
cooling the graphene-substrate slurry to form a graphene composite material.

2. The method of manufacturing a graphene composite material according to claim 1, wherein a material of the columnar substrate is metal, alloy or polymer.

3. The method of manufacturing a graphene composite material according to claim 2, wherein the metal is selected from at least one of lead, tin, zinc, aluminum and copper.

4. The method of manufacturing a graphene composite material according to claim 1, wherein a weight ratio of the columnar substrate to the graphene sheets is 99.9-90%:0.1-10%.

5. The method of manufacturing a graphene composite material according to claim 1, wherein the plasticized substrate is formed by rotationally rubbing a surface of the columnar substrate with a rotating mold, to allow a temperature of the columnar substrate reach between 70% and 100% of a melting point of the columnar substrate.

6. The method of manufacturing a graphene composite material according to claim 5, wherein the shear force stirring the graphene sheets and the plasticized substrate to form the graphene-substrate slurry is applied by a rotating flow channel, which is located inside the rotating mold.

7. The method of manufacturing a graphene composite material according to claim 6, wherein the rotating mold comprises an outer mold and an inner mold, the rotating flow channel is located between the outer mold and the inner mold, the outer mold has inner lugs formed on an inner surface thereof, the inner mold has outer lugs formed on an outer surface thereof, the inner lugs and the outer lugs are in a stagger arrangement, when the outer mold rotates relative to the inner mold, the inner lugs and the outer lugs generate the shear force.

8. A graphene composite material, comprising:
a columnar substrate accounting for 99.9-90% of an overall weight of the graphene composite material; and
graphene sheets accounting for 0.1-10% of the overall weight of the graphene composite material, wherein the graphene sheets form a plurality of circular patterns of different radii on a radial section of the columnar substrate.

9. The graphene composite material according to claim 8, wherein the columnar substrate is metal, alloy or polymer.

10. The graphene composite material according to claim 8, wherein an average thickness of each of the graphene sheets is between 1 and 3 nm, and an average diameter of each of the graphene sheets is between 1 and 15 μm.
